(19) United States
(12) Patent Application Publication
(10) Pub. No.: US 2006/0162578 A1
(43) Pub. Date: Jul. 27, 2006

(54) Citrus squeezer and advertising means

(76) Inventors: Tony Zellmer, Eagle, WI (US); Daniel Oas, Irwindale, CA (US)

Correspondence Address: THE SONI LAW FIRM, 55 S. LAKE AVE SUITE 720, PASADENA, CA, 91101, US

(21) Appl. No.: 11/045,549

(22) Filed: Jan. 27, 2005

(51) Int. Cl. A23N 1/00

(52) U.S. Cl. 99/495

(57) ABSTRACT

A fruit squeezer having a generally wedge shaped compliant body into which a section of fruit is inserted. The squeezer further includes a gripping means by which it is secured to the sidewall of a beverage container such that upon squeezing the wedge shaped body, juice is extracted from the fruit section and flows down the center of the wedge shaped body channel directly into the beverage container. The outer surfaces of the fruit squeezer, having relatively smooth surfaces, are also well-suited for application of art work, logos and graphics for advertising and promotional purposes.

### BACKGROUND OF THE INVENTION

Many new beverages, both alcoholic and non-alcoholic, as well as other recipes suggest an improved taste results from extraction of the juices of a fruit wedge into the beverage. This has long been accomplished by simply pressing a fruit wedge into the top rim of a glass or inserting a wedge part way into a bottle. Neither method is advantageous, however, as each leaves the consumer with the task of squeezing the fruit or pushing it into the bottle. In either situation, the juice extraction is messy and seldom efficient.

Juice extractors of a counter top size, such as that described in U.S. Pat. No. 4,530,277 to Matsumoto, have long been in use, however, their extremely large size and cost prohibits their use on an individual consumer basis. Many hand tools have been designed for fruit juice squeezing, however, none of these designs are suitable for individual consumer use as required in a restaurant of bar, due to their size, cost and messy handling of the juice. An example of this type of fruit squeezer is described in U.S. Pat. No. 3,580,168 to Zysset. This type of device is clearly bulky, costly and would be inefficient as a disposable fruit squeezer for home or restaurant use.

Bulky contraptions have recently been invented to accomplish the fruit juice introduction into a beverage. For example, U.S. Pat. No. 6,568,155 to Segal describes a plunger type mechanism which purports to inject an entire fruit wedge section into a bottle. This device, however, is inefficient, as it thrusts the entire fruit section into the bottle, rather than simply permitting the juice to enter the bottle. Moreover, the device is necessarily limited to use with bottles, due to its small round lower orifice. Most importantly, this type of device is bulky and contains numerous components, thereby rendering it prohibitively expensive for use as a fruit injector to be reused or disposed at the user's whim.

Some attempts have been made to develop an individual disposable fruit squeezer. U.S. Pat. No. 3,669,013 to Stein and U.S. Pat. No. 3,754,502 to Kaufman each describe individual use fruit squeezers. The Stein version, however, is simply a squeezer and has no attachment or other means by which the juice may easily flow into a bottle or glass. Similarly, the Kaufman device is a squeezer which necessarily resides outside the beverage receptacle, thus requiring the user to accomplish the squeezing and transfer of juice again without ready means for transference into the receptacle. As such, both of these types of squeezers are inefficient, messy and not easily used be the typical consumer.

What is needed is a simple low cost device in which the user may squeeze the juice of a fruit section into any commonly used receptacle. Such a device should be disposable and would be improved if its surfaces were designed and constructed in a manner to facilitate the imprinting of advertising or other graphical content.

### SUMMARY OF THE INVENTION

The present invention meets the need for a simple efficient and economical device which will enable the user to squeeze a fruit section for juice extraction directly into a beverage container, regardless of construction of the container. Moreover, the simple design of the present invention facilitates low cost production thereby rendering the device disposable if the user or purveyor so desires. Finally, the present invention, having generally flat sides, nicely meets the need for use as an advertising vehicle, as logos, advertising or other graphical material may be imprinted on its exterior surfaces.

The present invention contemplates a generally wedge shaped elongated body section having at least two upwardly angled walls between which a fruit wedge or section is placed. The lower end of the device includes a pair of generally parallel finger-like extensions which slip over the rim of the receptacle so as to position the wedge shaped body perpendicular to the top edge of the beverage container and at a descending angle with respect to the edge to permit juices to flow into the container. The inner of the two fingers is formed integrally with the base of the wedge shape thereby creating a lengthwise channel from the base of the wedge to the bottom end of the inner finger to permit uninterrupted flow of the extracted juice into the container.

Once a section of fruit is placed into the wedge opening, the device is pressed onto the edge rim of a container and the two elongated fingers retain the device in the preferred orientation. The user then simply squeezes the device, typically with thumb and index finger, causing the fruit's juices to be extracted and flow down the wedge channel and directly into the receptacle. In so doing, the user may add the appropriate amount of juice as desired to taste. Following extraction of the juices, the squeezer may remain in place, may be refilled with another fruit section or may be disposed.

### BRIEF DESCRIPTION OF THE DRAWINGS

FIG. 1 is a top perspective view of a preferred embodiment of the Fruit Squeezer, which shows the wedge shaped body, continuous channel and two elongated fingers.

FIG. 2 is a front view of a preferred embodiment of the Fruit Squeezer, which again shows wedge shaped squeezer body and channel.

FIGS. 3 and 4 are mirror image side views of a preferred embodiment of the Fruit Squeezer, which show the two elongated fingers which grasp the side of the beverage container.

FIG. 5 is a bottom plan view of a preferred embodiment of the Fruit Squeezer, which shows the opening between the two fingers and the contour of the wedge shaped body.

FIG. 6 is a top plan view of a preferred embodiment of the Fruit Squeezer, which shows the wedge shaped body and top end portion of the fingers.

FIG. 7 is a rear view of a preferred embodiment of the Fruit Squeezer, which shows outside of the wedge shaped body and the back portion of the outer finger which would reside outside the receptacle when in use.

FIGS. 8 and 9 depict views of a preferred embodiment of the Fruit Squeezer, as it would be slipped onto the rim of the container and be held in place by means of the two fingers. FIG. 9 shows the method by which an individual would typically squeeze the device to extract juice into the beverage container.

### DETAILED DESCRIPTION OF THE PREFERRED EMBODIMENT

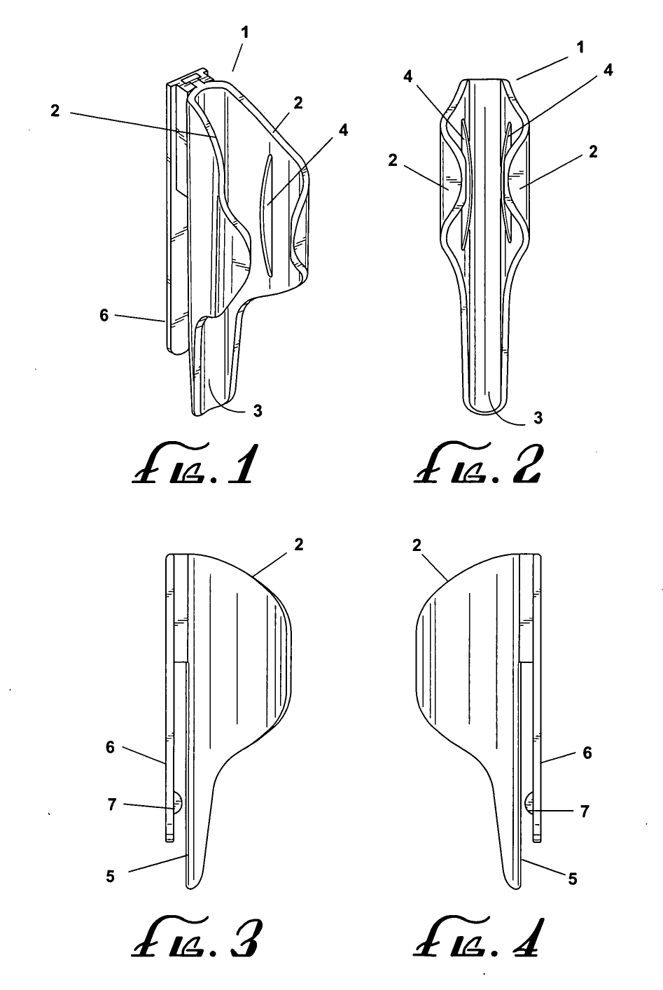

Referring to FIGS. 1, 2 and 5, the preferred embodiment of the Fruit Squeezer has a generally wedge shaped body 1. The wedge shaped body 1, is defined by two upwardly angled sides 2, and a center channel 3. The body 1 sides 2 and center channel 3 may be formed as a single assembly or may be discrete components which are bonded or otherwise attached to form the fruit squeezer. In the preferred embodiment, the fruit squeezer may be fabricated as a molded polymer piece, however, it may alternatively be constructed of other materials and may be fabricated by other means which would result in the flexible shape of the main body 1, sides 2 and channel 3. The channel 3, while described in the preferred embodiment as a being located in the center of the wedge sides 2, may alternatively be positioned in any location whereby the extracted juices would flow into the associated beverage container. In addition, perforated holes or raised edges or portions may be present in the channel area, so as to impede the transfer of seeds from the fruit into the beverage container.

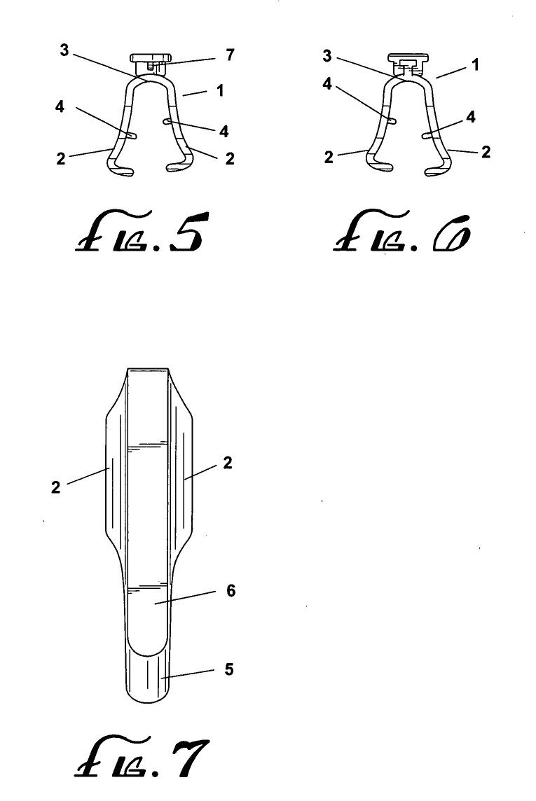

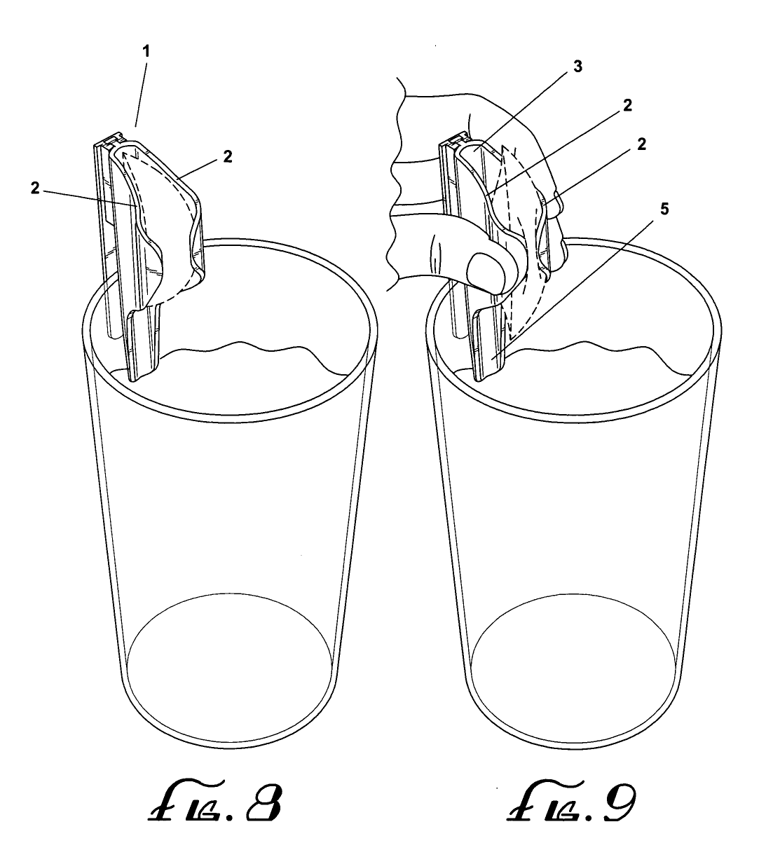

In the preferred embodiment, each side 2 may further include an insert blade 4, which functions to both grasp the fruit section and improve the juicing function by cutting the individual pulp segments. As shown in FIGS. 3, 4 and 7, the preferred embodiment further includes a pair of elongated fingers 5 and 6, with one finger being an inner finger 5 which is formed integrally with the wedge body 1 so as to form a continuous channel 3 along the entire inner length of the squeezer. The outer finger 6 may further include a ball tab 7, shown in FIGS. 4 and 5, proximate the inside end of said finger 6. This tab 7 may be incorporated in the structure to ensure the fingers tightly grasp the sidewall of a beverage container while in use, regardless of the thickness of the container wall.

FIG. 8 depicts the Fruit Squeezer with a section of fruit inserted into the wedge shaped body 1. As shown in the drawing, the fingers 5 and 6 are slipped over the rim of the beverage container and slide down the sidewall of the container to permit the squeezer to maintain a secure position whereby the wedge shaped body 1 is oriented and positioned to permit squeezing of the fruit section and the resultant flow of its juices directly into the beverage container.

FIG. 9 shows the preferred embodiment of the Fruit Squeezer as it would be used by an individual consumer. By applying inward pressure on the sides 2, in this case, with thumb, index and middle finger, the sides 2 are compressed together, thereby squeezing the fruit section between the sides 2. When included in the preferred embodiment, the blades 4 further assist in the juice extraction by cutting into the fruit section and tearing the pulp segments. As shown in FIG. 9, the center channel 3 then permits the extracted juices to flow directly into the beverage container.

Although the typical use of the invention would be for squeezing a citrus type fruit, the fruit squeezer could readily be used for any fruit for which the user desires juices, pulp or portions to be extracted into a container.

The outer surfaces of the sides 2 and outer finger 6, having relatively smooth surfaces, are also well-suited for application of art work, logos and graphics for advertising and promotional purposes.

What is claimed is:

1. A fruit squeezer comprising:
a flexible body for holding and squeezing a fruit section,
a channel to permit flow of extracted juices directly from the fruit section into a beverage container; and
a gripping means by which the fruit squeezer may be retained to a beverage container.

2. The fruit squeezer of claim 1 whereby the body is formed by two
upwardly angled sides with the channel formed at the convergence of the sides.

3. The fruit squeezer of claim 1 wherein the gripping means further comprises two elongated fingers which clamp onto the sidewall of a beverage container.

4. The fruit squeezer of claim 2 wherein each side further includes a generally perpendicular inwardly facing blade member.

5. The fruit squeezer of claim 3 wherein at least one of the fingers further includes a projecting tab on its gripping surface.

6. The fruit squeezer of claim 1 further including printed or graphical imprinting on at least one surface for the purposes of advertising or promotion of goods or services.

7. A fruit squeezer comprising:
a flexible wedge shaped body formed by two upwardly angled sides for holding and squeezing a fruit section,
a lengthwise channel formed between said sides, to permit flow of extracted juices directly from the fruit section into a beverage container; and
a gripping means comprising two elongated finger sections whereby the sidewall of a beverage container may be gripped between said fingers by which the fruit squeezer may be retained to a beverage container.

9. The fruit squeezer of claim 8 further including printed or graphical imprinting on at least one surface for the purposes of advertising or promotion of goods or services.

10. A method of advertising or promotion comprising the imprinting of printed or graphical material on at least one outer surface of a fruit squeezer which has:
a flexible body for holding and squeezing a fruit section,
a channel to permit flow of extracted juices directly from the fruit section into a beverage container; and
a gripping means by which the fruit squeezer may be retained to a beverage container.
